(19) United States
(12) Patent Application Publication
(10) Pub. No.: US 2023/0042631 A1
(43) Pub. Date: Feb. 9, 2023

(54) Infrared Transceiver Unit, Detection Apparatus, Multi-Infrared Detection Apparatus and Obstacle Avoidance Robot

(71) Applicant: AMICRO SEMICONDUCTOR CO., LTD., Zhuhai, Guangdong (CN)

(72) Inventors: Qinwei LAI, Zhuhai, Guangdong (CN); Gangjun XIAO, Zhuhai, Guangdong (CN)

(21) Appl. No.: 17/790,144

(22) PCT Filed: Aug. 24, 2020
(86) PCT No.: PCT/CN2020/110693

§ 371 Date: Jun. 30, 2022

(30) Foreign Application Priority Data
Feb. 25, 2020 (CN) 202010117197.2

(51) Int. Cl. A47L 11/40; G05D 1/02

(52) U.S. Cl. CPC A47L 11/4061; A47L 11/4011; G05D 1/0238; G05D 1/0242; A47L 2201/04; G05D 2201/0203

(57) ABSTRACT

An infrared transceiver unit (107, 108), a detection apparatus, a multi-infrared detection apparatus and an obstacle avoidance robot. The infrared transceiver unit (107, 108) includes a mounting skewed slot, an infrared emitting source (1085), and two groups of infrared receiving sources (1083, 1084), wherein a sensing direction of one group of infrared receiving sources (1084) and an emitting direction of the infrared emitting source (1085) both face one side of a sensing center line (L) of the mounting skewed slot, and the sensing direction of the other group of infrared receiving sources (1083) faces the other side of the sensing center line (L) of the mounting skewed slot, so that one of the infrared receiving sources (1083, 1084) receives infrared modulation light emitted by the infrared emitting source and reflected by an obstacle. Two infrared transceiver units (107, 108) are respectively arranged on a left end and a right end of an obstacle avoidance robot, and the infrared transceiver unit (107, 108) arranged on one end of the robot receives the infrared modulation light emitted by the infrared transceiver unit (107, 108) arranged on the other end, or the infrared modulation light emitted by the infrared transceiver unit (107, 108) arranged on either end and reflected by the obstacle.

### CROSS-REFERENCE TO RELATED APPLICATIONS

The present disclosure takes the Chinese Patent Application No. 202010117197.2, filed on Feb. 25, 2020, and entitled “Infrared Transceiver Unit, Detection Apparatus, Multi-Infrared Detection Apparatus and Obstacle Avoidance Robot”, as the priority, the entire contents of which are incorporated herein by reference.

### TECHNICAL FIELD

The disclosure belongs to the technical field of infrared obstacle avoidance, and particularly relates to an infrared transceiver unit, a detection apparatus, a multi-infrared detection apparatus and an obstacle avoidance robot.

### BACKGROUND

With the technical development and the pursuit of people for comfortable life, more and more autonomous robots enter the life of people, such as companion robots and floor mopping robots. Basic functions of the robots are environment perception, instruction reception and behavior control. The first difficulty of a robot is environment perception, the robot needs to know where to go, what obstacles are in front, whether there is a wall on a side surface, and so on. The environment perception also needs to rely on the acquisition of all kinds of sensor data. At present, common sensors include: infrared light intensity sensors, infrared distance sensors, ultrasonic sensors, visual sensors, laser sensors, etc. In terms of accuracy, infrared ranging sensors, ultrasonic sensors and laser sensors can all achieve relatively high accuracy, but the costs are relatively high, and angles covered by the sensors other than the laser sensor are relatively small, so that a relatively large number of sensors are required to reduce the blind region of detection. However, the laser sensor mainly perceives a very narrow two-dimensional plane, therefore there is a blind region in a vertical direction.

To realize ranging, a visual sensor requires at least two cameras, so that the cost is relatively high, the accuracy is not good, and a special hole is needed on a mold for placement. In terms of cost and appearance, the infrared light intensity sensors are undoubtedly the cheapest and most widely used, but the current use methods are based on single light intensity detection, different materials emit different infrared rays, and a black surface cannot reflect the infrared rays effectively, resulting in worse adaptability to obstacles, and a detectable region is not large.

### SUMMARY

In order to solve the above technical problems, the technical solution of the present invention relies on a limiting effect of a mold structure to realize wide-range obstacle detection in front of a machine, so that it can detect the obstacles between two infrared transceiver units. The specific technical solution is as follows:

An infrared transceiver unit, including a mounting skewed slot, an infrared emitting source and infrared receiving sources, wherein the mounting skewed slot includes a left mounting skewed slot and a right mounting skewed slot; the infrared emitting source is fixedly installed in the left mounting skewed slot, and two groups of infrared receiving sources are fixedly installed in the right mounting skewed slot, or the infrared emitting source is fixedly installed in the right mounting skewed slot, and two groups of infrared receiving sources are fixedly installed in the left mounting skewed slot; and a sensing direction of one group of infrared receiving sources and an emitting direction of the infrared emitting source both face one side of a sensing center line of the mounting skewed slot, and the sensing direction of the other group of infrared receiving sources faces the other side of the sensing center line of the mounting skewed slot, so that one of the infrared receiving sources receives infrared modulation light emitted by the infrared emitting source and reflected by an obstacle. By means of the mounting manner of the infrared emitting source and the infrared receiving sources disclosed in the technical solution, wide-range obstacle detection in front of the infrared transceiver unit is realized, and the utilization rate of the infrared modulation light emitted by the infrared emitting source is improved. In the present invention, the obstacles are detected by using the modulated light, and in combination with the foregoing limiting mold structure, the difference in detectable distances of the infrared modulation light on black and white obstacles is reduced, and meanwhile, the mold production cost is lower.

Furthermore, one group of infrared receiving sources is inclined in the same direction as the infrared emitting source, the two groups of infrared receiving sources receive the infrared modulation light by means of respective light path channel ports at diffusion angles, so as to form a receiving range of the mounting skewed slot, the infrared emitting source emits the infrared modulation light by means of its light path channel port at a diffusion angle, so as to form an emitting range of the mounting skewed slot, wherein the receiving range is greater than the emitting range. In the technical solution, by setting a relative position relationship between the infrared receiving source and the infrared emitting source, a detection width of an infrared detectable region in a horizontal direction is expanded, and a detection effect is improved.

Furthermore, there is an infrared demodulation receiving tube in each group of infrared receiving sources, and the infrared emitting source is an infrared emitting tube; and the infrared emitting tube utilizes small-current constant-current control and is in a low emitting power state. In order to limit the infrared emitting power at a relatively small level, the infrared tube in the technical solution utilizes small-current constant-current control, so as to reduce the phenomenon that a secondary reflected signal can still be identified.

Furthermore, lenses or infrared-transmitting light filters are arranged at the light path channel ports of the left mounting skewed slot and the right mounting skewed slot. The structure is simple, and it is conducive to filtering out interference light sources.

Furthermore, the infrared transceiver unit further includes a telescopic traction mechanism, the telescopic traction mechanism has a connection relationship with a mounting surface of the mounting skewed slot for pulling the mounting skewed slot to perform telescopic movement. On the basis of a convex hull structure formed by the lens or the infrared-transmitting light filter on the mounting skewed slot, the telescopic traction mechanism can pull the mounting skewed slot to retract when the infrared transceiver unit collides with an obstacle, so as to achieve a physical contact detection effect of the obstacle.

Furthermore, the telescopic traction mechanism is a spring movable structure connected to a bottom mounting surface of the mounting skewed slot. Therefore, the infrared transceiver unit has a certain elastic force, thus can contract when encountering external extrusion, and is used for triggering a collision signal at the same time.

A detection apparatus. As a first technical solution, the detection apparatus includes two infrared transceiver units and a horizontally arranged mounting slot; the two infrared transceiver units are respectively arranged on a left end and a right end of the mounting slot, so that the infrared transceiver unit arranged on one end of the mounting slot receives: infrared modulation light emitted by the infrared transceiver unit arranged on the other end of the mounting slot, or infrared modulation light emitted by the infrared transceiver unit arranged on either end of the mounting slot and reflected by an obstacle; in the infrared transceiver unit arranged on the left end of the mounting slot, the infrared emitting source is fixedly installed in the right mounting skewed slot, and the two infrared receiving sources are fixedly installed in the left mounting skewed slot; in the infrared transceiver unit arranged on the right end of the mounting slot, the infrared emitting source is fixedly installed in the left mounting skewed slot, and the two infrared receiving sources are fixedly installed in the right mounting skewed slot, wherein the infrared receiving source that is inclined in the same direction as the infrared emitting source faces an inner side of the mounting slot, and the other infrared receiving source faces an outer side of the mounting slot; and the infrared transceiver units on different ends emit the infrared modulation light in different time periods. In the technical solution, the detection apparatus has a functional effect of detecting and identifying the azimuth information of the obstacle relative to the center line of the apparatus. Moreover, an overall limiting structure formed by the two infrared transceiver units in cooperation with the horizontally arranged mounting slot improves the utilization rate of the infrared modulation light emitted by the infrared emitting source, and ensures a small difference in the detectable distances of the infrared modulation light on the black and white obstacles in a detectable region of the obstacles.

As a second technical solution, the infrared transceiver unit further includes a telescopic traction mechanism, one end of the telescopic traction mechanism has a connection relationship with the mounting surface of the mounting skewed slot, and the other end of the telescopic traction mechanism is fixedly connected to the mounting slot for pulling the mounting skewed slot to perform telescopic movement. In the technical solution, a contact collision signal is triggered in an obstacle collision process, so as to protect the infrared transceiver unit.

A multi-infrared detection apparatus. As a third technical solution, the multi-infrared detection apparatus includes a horizontally arranged mounting slot, and at least two groups of infrared transceiver units arranged in pairs, wherein the infrared transceiver units arranged in pairs are two infrared transceiver units; these infrared transceiver units arranged in pairs are continuously arranged in the mounting slot, or, the two infrared transceiver units arranged in pairs are respectively arranged on both sides of a horizontal center line of the mounting slot, and are symmetrically arranged from the outer side to the inner side of the mounting slot in sequence by taking the horizontal center line of the mounting slot as an axis of symmetry; in the two infrared transceiver units arranged in pairs, one infrared transceiver unit receives the infrared modulation light emitted by the other infrared transceiver unit, or, the infrared modulation light emitted by any of the infrared transceiver units and reflected by an obstacle; in the two infrared transceiver units arranged in pairs, for the infrared transceiver unit arranged on a left side, the infrared emitting source is fixedly installed in the right mounting skewed slot, and the two infrared receiving sources are fixedly installed in the left mounting skewed slot; and for the infrared transceiver unit arranged on a right side, the infrared emitting source is fixedly installed in the left mounting skewed slot, and the two infrared receiving sources are fixedly installed in the right mounting skewed slot, wherein each infrared transceiver unit emits the infrared modulation light in different time periods. Compared with the foregoing technical solution, the technical solution refines the range of an obstacle detection region on a front end of the apparatus, thereby improving the detection effect.

As a fourth technical solution, the infrared transceiver unit further includes a telescopic traction mechanism, one end of the telescopic traction mechanism has a connection relationship with the mounting surface of the mounting skewed slot, and the other end of the telescopic traction mechanism is fixedly connected to the mounting slot for pulling the mounting skewed slot to perform telescopic movement. The technical solution is used for triggering a contact collision signal to drive the infrared transceiver unit to retract so as to avoid colliding with obstacles, thereby protecting the infrared transceiver unit.

As a fifth technical solution, there is at least one layer of infrared transceiver units that are continuously arranged in the mounting slot, and adjacent layers are arranged in an alignment or malposition manner. It is adapted to actual detection environments.

An obstacle avoidance robot, wherein the detection apparatus according to the first technical solution or the multi-infrared detection apparatus according to the third technical solution or the fifth solution is installed in a concave mounting surface of the robot in a forward direction; or, the detection apparatus according to the second technical solution or the multi-infrared detection apparatus according to the fourth technical solution is installed on an end face of the robot in the forward direction. The robot in the technical solution can perform obstacle detection by using infrared modulation light, and realizes wide-range obstacle detection in front of the robot in cooperation with a mechanism, therefore the detection effect is good, and the perception ability of the robot is improved, so that the robot can be prevented from being clamped during an obstacle avoidance turning process.

### BRIEF DESCRIPTION OF THE DRAWINGS

FIG. 1 is a first structural schematic diagram of an obstacle avoidance robot of the disclosure.

FIG. 2 is a schematic structural diagram of an infrared transceiver unit 108 (including a spring movable structure) of FIG. 1.

FIG. 3 is a second structural schematic diagram of the obstacle avoidance robot of the disclosure.

FIG. 4 is a third structural schematic diagram of the obstacle avoidance robot of the disclosure.

FIG. 5 is a top view of a detection apparatus and a light path diagram for detecting obstacles in of the disclosure.

### DETAILED DESCRIPTION OF THE EMBODIMENTS

Embodiments of the present invention will be described in detail below in combination with the drawings, but the present invention can be implemented in many different manners as defined and covered by the claims. It should be noted that, unless otherwise specified, when a certain feature is called “fixed” or “connected” to another feature, it can be directly fixed or connected to the other feature, or it can be indirectly fixed or connected to the other feature. In addition, descriptions such as upper, lower, left and right used in the present invention are only relative to mutual position relationships of various components of the present invention in the drawings, unless otherwise specified. Further, unless otherwise defined, all technical and scientific terms used herein have the same meanings as commonly understood by those of ordinary skill in the art. The terms used in the specification herein are for the purpose of describing specific embodiments only, and not for the purpose of limiting the present invention. The term “or” used in the present invention includes any arrangement and combination of one or more related units and apparatuses listed.

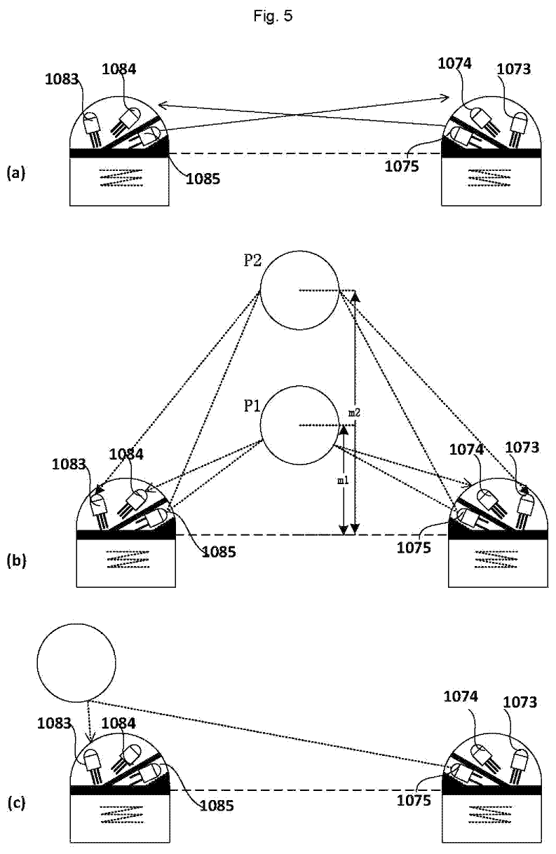

The embodiment of the present invention disclose an infrared transceiver unit. The infrared transceiver unit includes a mounting skewed slot, an infrared emitting source and infrared receiving sources. The mounting skewed slot includes a left mounting skewed slot and a right mounting skewed slot, which are respectively arranged on a left side and a right side of the mounting skewed slot for mounting infrared tubes with matching shapes. As a structural form of the infrared transceiver unit, as shown in FIG. 2, the infrared emitting source is fixedly installed in the right mounting skewed slot, two groups of infrared receiving sources are fixedly installed in the left mounting skewed slot, there is preferably an infrared demodulation receiving tube in each group of infrared receiving sources, correspondingly including an infrared demodulation receiving tube 1083 and an infrared demodulation receiving tube 1084 in FIG. 2, the infrared emitting source is an infrared emitting tube, which corresponds to an infrared emitting tube 1085 in FIG. 2, a sensing direction (i.e., a receiving direction) of the infrared demodulation receiving tube 1084 and the infrared demodulation receiving tube 1085 both face the right side of a sensing center line (a dotted line L in FIG. 2) of the mounting skewed slot, and the sensing direction (i.e., the receiving direction) of the infrared demodulation receiving tube 1083 faces the left side of the sensing center line (the dotted line L in FIG. 2) of the mounting skewed slot. As another structural form of the infrared transceiver unit, it can be seen in combination with FIG. 5 that, the infrared emitting source is fixedly installed in the left mounting skewed slot, and two groups of infrared receiving sources are fixedly installed in the right mounting skewed slot, which is equivalent to that the infrared transceiver unit shown in FIG. 2 is symmetrically turned over relative to the sensing center line of the mounting slot, there is preferably an infrared demodulation receiving tube in each group of infrared receiving sources, correspondingly including an infrared demodulation receiving tube 1073 and an infrared demodulation receiving tube 1074 in FIG. 5, the infrared emitting source is an infrared emitting tube, which corresponds to an infrared emitting tube 1075 in FIG. 5, the sensing direction (i.e., the receiving direction) of the infrared demodulation receiving tube 1074 and the infrared demodulation receiving tube 1075 both face the left side of the sensing center line of the mounting skewed slot, and the sensing direction (i.e., the receiving direction) of the infrared demodulation receiving tube 1073 faces the right side of the sensing center line of the mounting skewed slot. In the above infrared transceiver unit, the sensing direction of one group of infrared receiving sources and an emitting direction of the infrared emitting source both face one side of the sensing center line of the mounting skewed slot, and the sensing direction of the other group of infrared receiving sources faces the other side of the sensing center line of the mounting skewed slot, so that one of the infrared receiving sources receives infrared modulation light emitted by the infrared emitting source and reflected by an obstacle.

The specific detection manner is: when the obstacle is relatively close to the infrared transceiver unit, since the obstacle is detected by using the infrared modulation light, it is necessary to limit a detectable distance of the obstacle within a certain distance range, therefore the closest detection distance of a detection region of the obstacle is recorded as a distance m1, as shown in FIG. 5(b), the infrared demodulation receiving tube 1084 receives the infrared modulation light emitted by the infrared emitting tube 1085 and reflected by an obstacle P1, wherein the detectable distance from the obstacle P1 to the infrared transceiver unit is m1; when the obstacle is relatively far away from the infrared transceiver unit, since the obstacle is detected by using the infrared modulation light, it is necessary to limit the detectable distance of the obstacle within a certain distance range, therefore the farthest detectable distance of the detection region of the obstacle is recorded as a distance m2, as shown in FIG. 5(b), the infrared demodulation receiving tube 1083 receives the infrared modulation light emitted by the infrared emitting tube 1085 and reflected by an obstacle P2, wherein the detectable distance from the obstacle P2 to the infrared transceiver unit is m2; in order to limit the detection distance within a certain range in the present invention, the mounting skewed slot cooperates with the infrared emitting source and the infrared receiving sources to form the foregoing limiting structure, so that the obstacle is located between the detectable distance m1 and the detectable distance m2, both white obstacles and black obstacles can be detected, and the difference in the detectable distances therebetween is small, therefore the difference in the detectable distances of the infrared modulation light on black and white obstacles is reduced. In combination with FIG. 5(b) and FIG. 5(c), it can be seen that the obstacle in FIG. 5(c) is a certain distance away from the obstacles P1 and P2 in FIG. 5(b) in a horizontal direction, and at this time, the infrared modulation receiving tube 1083 can also receive the infrared modulation light emitted by the infrared emitting tube 1075 of the infrared transceiver unit in the other structural form or emitting sources in other directions and reflected by the obstacle (an oblique circular obstacle); and it can be seen from FIG. 5(a) that, the infrared demodulation receiving tube 1083 receives the infrared modulation light directly emitted by the infrared emitting tube 1075. In conclusion, by means of the mounting manner of the infrared emitting source and the infrared receiving sources disclosed in the present invention, wide-range obstacle detection in front of the infrared transceiver unit is realized, and the utilization rate of the infrared modulation light emitted by the infrared emitting source is improved. In the present invention, the obstacles are detected by using the modulated light, and in combination with the foregoing limiting mold structure, the difference in the detectable distances of the infrared modulation light on the black and white obstacles is reduced, and meanwhile, the mold production cost is lower.

Preferably, one group of infrared receiving sources is inclined in the same direction as the infrared emitting source, specifically: the infrared demodulation receiving tube 1084 in the group of infrared receiving sources that face the right side of the sensing center line L in FIG. 2 is inclined in the same direction as the infrared emitting tube 1085, the infrared emitting tube 1085 is inclined in the same direction as the right mounting skewed slot, the center line of the infrared demodulation receiving tube 1084 and the center line of the infrared emitting tube 1085 are arranged in parallel in the same direction or intersect with each other on the right side of the sensing center line L to form a small included angle, a mounting plate of the right mounting skewed slot forms an acute angle with a horizontal mounting surface, and the mounting plate of the left mounting skewed slot forms an obtuse angle with the horizontal mounting surface; and the infrared demodulation receiving tube 1074 in the group of infrared receiving sources that face the right side of the sensing center line L in FIG. 5 is inclined in the same direction as the infrared emitting tube 1075, the center line of the infrared demodulation receiving tube 1074 and the center line of the infrared emitting tube 1075 are arranged in parallel in the same direction or intersect with each other on the left side of the sensing center line to form a small included angle, the infrared emitting tube 1075 is inclined in the same direction as the left mounting skewed slot, the mounting plate of the left mounting skewed slot forms an acute angle with the horizontal mounting surface, and the mounting plate of the right mounting skewed slot forms an obtuse angle with the horizontal mounting surface. The two groups of infrared receiving sources receive the infrared modulation light by means of respective light path channel ports at diffusion angles, so as to form a receiving range of the mounting skewed slot, the infrared emitting source emits the infrared modulation light by means of its light path channel port at a diffusion angle, so as to form an emitting range of the mounting skewed slot, wherein the receiving range is greater than the emitting range. Therefore, as shown in FIG. 2, on the same infrared sensing plane, the radian corresponding to the light path channel port arranged in the mounting skewed slot where the infrared emitting source of the infrared transceiver unit is located is less than the radian of the light path channel port arranged in the mounting skewed slot where the infrared receiving source is located. An overlapping degree of beam regions covered by a receiving angle 201 of the infrared demodulation receiving tube 1083 in FIG. 2 and a receiving angle 202 of the infrared demodulation receiving tube 1084 in FIG. 2 is not high, an emission angle 203 formed by the infrared emitting tube 1085 in FIG. 2 in the light path channel port is relatively small, and the sum of the radians (the sum of non-overlapping angles of the receiving angle 201 and the receiving angle 202) of the light path channel ports formed in the mounting skewed slot by the two receiving tubes that face the two sides of the sensing center line is greater than the radian (such as the emission angle 203 in FIG. 2) of the light path channel port formed in the mounting skewed slot by a single emitting tube that faces one side of the sensing center line, therefore a detection width of an infrared detectable region in the horizontal direction is further expanded. In the present embodiment, by setting a relative position relationship between the infrared receiving source and the infrared emitting source, the receiving range of detection signals by the infrared receiving source is expanded, and the detection effect is improved.

In the foregoing embodiment, the infrared emitting tube utilizes small-current constant-current control and is in a low emitting power state. Due to the utilization of the modulated light, a problem will occur that the detection distance is long and the signal is weakened. In order to limit the detection distance within a range, it is also necessary to adjust the power of the emitting tube to match mold structure limiting. In order to limit the infrared emitting power at a relatively small level, the infrared tube in the technical solution utilizes small-current constant-current control, so as to reduce the phenomenon that a secondary reflected signal can still be identified.

Preferably, lenses or infrared-transmitting light filters are arranged at the light path channel ports of the left mounting skewed slot and the right mounting skewed slot, so that the light path channel ports of the mounting skewed slots can be closed, and then the environment where the infrared emitting source and the infrared receiving sources are located is clearer. As shown in FIG. 2, the infrared emitting tube 1085, the infrared demodulation receiving tube 1083 and the infrared demodulation receiving tube 1084 select the same lens 1082 (including the infrared-transmitting light filter) that covers the corresponding light path channel port of the mounting skewed slot where they are located, so that the structure is simple, and it is conducive to filtering out interference light sources.

The infrared transceiver unit can further include a telescopic traction mechanism 1081, the telescopic traction mechanism 1081 has a connection relationship with a mounting surface of the mounting skewed slot for pulling the mounting skewed slot to perform telescopic movement. On the basis of a convex hull structure formed by the lens or the infrared-transmitting light filter on the mounting skewed slot, the telescopic traction mechanism 1081 can pull the mounting skewed slot to retract when the infrared transceiver unit collides with an obstacle, so as to achieve a physical contact detection effect of the obstacle. As shown in FIG. 2, the telescopic traction mechanism 1081 is a spring movable structure connected to a bottom mounting surface of the mounting skewed slot. Therefore, the infrared transceiver unit has a certain elastic force, thus can retract when encountering external extrusion, and is used for triggering a collision signal at the same time.

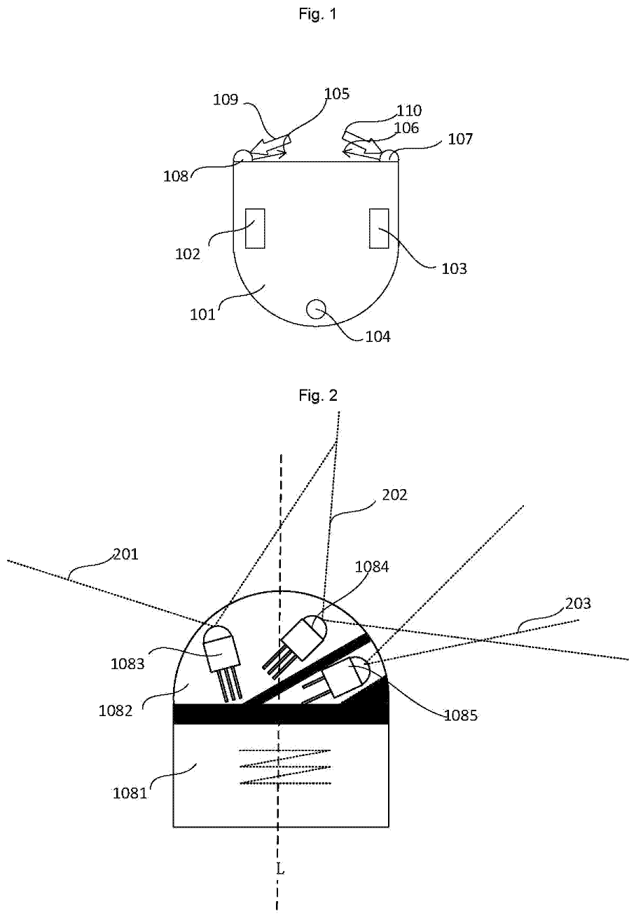

Based on the foregoing infrared transceiver unit, the present invention further provides a structural embodiment of a detection apparatus, which is assembled on an end face of a mobile robot in a forward direction, and is used for executing an infrared detection obstacle avoidance function, so as to form the schematic structural diagram of an obstacle avoidance robot shown in FIG. 1, wherein the detection apparatus includes two foregoing infrared transceiver units and a horizontally arranged mounting slot; the two infrared transceiver units are respectively arranged on a left end and a right end of the mounting slot, so that the infrared transceiver unit arranged on one end of the mounting slot receives: infrared modulation light emitted by the infrared transceiver unit arranged on the other end of the mounting slot, or infrared modulation light emitted by the infrared transceiver unit arranged on either end of the mounting slot and reflected by an obstacle. The detection apparatus can implement the foregoing detection manner. The infrared transceiver unit arranged on one end of the mounting slot receives the infrared modulation light in different time periods, including: firstly receiving the infrared modulation light emitted by the infrared transceiver unit arranged on the other end of the mounting slot, and then receiving the infrared modulation light emitted by the infrared transceiver unit arranged on either end of the mounting slot and reflected by the obstacle; or, firstly receiving the infrared modulation light emitted by the infrared transceiver unit arranged on either end of the mounting slot and reflected by the obstacle, and then receiving the infrared modulation light emitted by the infrared transceiver unit arranged on the other end of the mounting slot.

Specifically, in combination with FIG. 1, FIG. 2 and FIG. 5, it can be seen that in the infrared transceiver unit 108 arranged on the left end of the mounting slot, the infrared emitting source is fixedly installed in the right mounting skewed slot, and two groups of infrared receiving sources are fixedly installed in the left mounting skewed slot preferably. For the convenience of illustration, in the present embodiment, the number of each group of infrared receiving sources is sent to be one, that is, only one infrared demodulation receiving pipe is provided in each group, which is conducive to reducing the cost; and the sensing direction (i.e., the receiving direction) of the infrared demodulation receiving tube 1084 and the infrared demodulation receiving tube 1085 both face the right side of the sensing center line (the dotted line L in FIG. 2) of the mounting skewed slot, and the sensing direction (i.e., the receiving direction) of the infrared demodulation receiving tube 1083 faces the left side of the sensing center line (the dotted line L in FIG. 2) of the mounting skewed slot. It can be seen in combination with FIG. 2 and FIG. 5 that, the infrared demodulation receiving tube 1084 can be inclined in the same direction as the infrared emitting tube 1085, the infrared demodulation receiving tube 1084 that is inclined in the same direction as the infrared emitting tube 1085 faces the inner side of the mounting slot, and the other infrared demodulation receiving tube 1083 faces the outer side of the mounting slot. In the infrared transceiver unit 107 arranged on the right end of the mounting slot, the infrared emitting source is fixedly installed in the left mounting skewed slot, and two groups of infrared receiving sources are fixedly installed in the right mounting skewed slot preferably. For the convenience of illustration, in the present embodiment, the number of each group of infrared receiving sources is sent to be one, that is, only one infrared demodulation receiving pipe is provided in each group, which is conducive to reducing the cost; and the sensing direction (i.e., the receiving direction) of the infrared demodulation receiving tube 1074 and the infrared demodulation receiving tube 1075 both face the left side of the sensing center line of the mounting skewed slot, and the sensing direction (i.e., the receiving direction) of the infrared demodulation receiving tube 1073 faces the right side of the sensing center line of the mounting skewed slot. It can be seen in combination with FIG. 2 and FIG. 5 that, the infrared demodulation receiving tube 1074 can be inclined in the same direction as the infrared emitting tube 1075, the infrared demodulation receiving tube 1074 that is inclined in the same direction as the infrared emitting tube 1075 faces the inner side of the mounting slot, and the other infrared demodulation receiving tube 1073 faces the outer side of the mounting slot.

The infrared transceiver units on the left end and the right end of the mounting slot emit the infrared modulation light in different time periods, which is conducive to determining the azimuth characteristics of the obstacle. The specific detection method is as follows:

at a moment t1, the infrared emitting tube 1085 of the infrared transceiver unit 108 is controlled to be turned on to emit the infrared modulation light, the infrared emitting tube 1075 remains turned off, if the infrared receiving source of the infrared transceiver unit 108 does not receive the infrared modulation light, it can be determined that the obstacle is not located in the vicinity of a horizontal center line of the mounting slot, and the infrared receiving source of the infrared transceiver unit 107 receives the infrared modulation light emitted by the infrared emitting tube 1085. Then, it is further judged whether there is an obstacle on the right side of the infrared transceiver unit 107, if only the infrared demodulation receiving tube 1074 facing the inner side of the mounting slot receives the infrared modulation light emitted by the infrared emitting tube 1085, it is determined that there is no obstacle on the right side of the infrared transceiver unit 107, and since the obstacle is not located at the corner of the right end of the detection apparatus, the obstacle does not block the infrared modulation light emitted by the infrared transceiver unit 108; and if only the infrared demodulation receiving tube 1073 facing the outer side of the mounting slot receives the infrared modulation light emitted by the infrared emitting tube 1085, it is determined that there is an obstacle at the corner of the right end of the infrared transceiver unit 107.

At the moment t1, only the infrared demodulation receiving tube 1074 facing the inner side of the mounting slot receives the infrared modulation light emitted by the infrared emitting tube 1085. Then, at a moment t2 (t2>t1), the infrared emitting tube 1085 is turned off, the infrared emitting tube 1075 is then turned on to emit the infrared modulation light, if only the infrared demodulation receiving tube 1084 that faces the inner side of the mounting slot in the infrared transceiver unit 108 receives the infrared modulation light emitted by the infrared emitting tube 1075, it is determined that there is no obstacle on the left side of the infrared transceiver unit 108, and if only the infrared demodulation receiving tube 1083 facing the outer side of the mounting slot receives the infrared modulation light emitted by the infrared emitting tube 1075, it is determined that there is an obstacle at the corner of the left end of the infrared transceiver unit 108. As shown in FIG. 5(c), the obstacle located at the corner of the left end of the detection apparatus just blocks the infrared modulation light emitted by the infrared emitting tube 1075, and reflects the same to the infrared demodulation receiving tube 1083 that faces the outer side of the mounting slot in the infrared transceiver unit 108, therefore it is determined that the obstacle is located at the corner of the left end of the detection apparatus, and at the same time, the width of the detectable region of the detection apparatus in the horizontal direction is also widened.

At a moment t3, the infrared emitting tube 1085 and the infrared emitting tube 1075 are turned off to enter the next detection control cycle.

If the infrared emitting tube 1075 emits the infrared modulation light at first, the infrared emitting tube 1085 remains turned off, and if only the infrared demodulation receiving tube 1084 facing the inner side of the mounting slot receives the infrared modulation light emitted by the infrared emitting tube 1075, it is determined that there is no obstacle on the left side of the infrared transceiver unit 108, and since the obstacle is not located at the corner of the left end of the detection apparatus, the obstacle does not block the infrared modulation light emitted by the infrared transceiver unit 107; and if only the infrared demodulation receiving tube 1083 facing the outer side of the mounting slot receives the infrared modulation light emitted by the infrared emitting tube 1075, it is determined that there is an obstacle at the corner of the left end of the infrared transceiver unit 108. Then, the infrared emitting tube 1075 is turned off, and the infrared emitting tube 1085 is turned on to emit the infrared modulation light. If only the infrared demodulation receiving tube 1074 that faces the inner side of the mounting slot in the infrared transceiver unit 107 receives the infrared modulation light emitted by the infrared emitting tube 1085, it is determined that there is no obstacle on the right side of the infrared transceiver unit 107, and if only the infrared demodulation receiving tube 1073 facing the outer side of the mounting slot receives the infrared modulation light emitted by the infrared emitting tube 1085, it is determined that there is an obstacle at the corner of the right end of the infrared transceiver unit 107.

When the obstacle is located in the vicinity of the horizontal center line of the mounting slot, as shown in FIG. 5(b), the infrared demodulation receiving tube 1084 facing the inner side of the mounting slot receives the infrared modulation light that is emitted by the infrared emitting tube 1085 on the same end of the mounting slot and reflected by the closer obstacle P1 (closer to the horizontal line of the mounting slot), and the infrared demodulation receiving tube 1083 facing the outer side of the mounting slot receives the infrared modulation light that is emitted by the infrared emitting tube 1085 and reflected by the farther obstacle P2 (farther away from the horizontal line of the mounting slot); and the infrared demodulation receiving tube 1074 facing the inner side of the mounting slot receives the infrared modulation light that is emitted by the infrared emitting tube 1075 on the same end of the mounting slot and reflected by the closer obstacle P1 (closer to the horizontal line of the mounting slot), and the infrared demodulation receiving tube 1073 facing the outer side of the mounting slot receives the infrared modulation light that is emitted by the infrared emitting tube 1075 and reflected by the farther obstacle P2 (farther away from the horizontal line of the mounting slot), wherein the horizontal line of the mounting slot is a horizontal connecting line of the two infrared transceiver units in FIG. 5(b).

Therefore, the effects achieved by the foregoing embodiments include: when the infrared receiving source on the outer side (relative to the inner side of the mounting slot) of the infrared transceiver unit on one end of the mounting slot can receive a signal emitted by the infrared transceiver unit on the other end, there is an obstacle at the corner of the outer side of the infrared transceiver unit that emits the infrared modulation signal; when the infrared transceiver unit arranged on one end of the mounting slot can receive the infrared modulation light emitted by the infrared transceiver unit arranged on the other end, there is no obstacle on neither the inner side nor the outer side of the mounting slot; when the infrared receiving source of the infrared transceiver unit on one end of the mounting slot can also receive the signal emitted by the infrared transceiver unit on the same end, the infrared transceiver unit on which end emits the infrared modulation light, then the infrared transceiver unit on this end firstly receives the infrared modulation light reflected back by the obstacle, and the infrared receiving source that is deflected to the outer side of the mounting slot is more likely to receive the infrared modulation light reflected by the obstacle that is further away from the detection apparatus, there is an obstacle in the vicinity of the horizontal center line of the mounting slot, but it is also limited to the obstacle between the detectable distance m1 and the detectable distance m2 disclosed in the foregoing embodiment, and then it can be normally detected that the obstacle is at a position in the vicinity of the horizontal center line of the mounting slot. Therefore, a region between the center line of the infrared transceiver unit 107 and the center line of the infrared transceiver unit 108 can be expanded, so as to ensure the accuracy and precision of obstacle detection. To sum up, by means of the embodiment of the present invention, the detection apparatus has a functional effect of detecting and identifying the azimuth information of the obstacle relative to the center line of the apparatus. Moreover, an overall limiting structure formed by the two infrared transceiver units in cooperation with the horizontally arranged mounting slot improves the utilization rate of the infrared modulation light emitted by the infrared emitting source, and ensures a small difference in the detectable distances of the infrared modulation light on the black and white obstacles in the detectable region of obstacles.

It is worth noting that, the infrared modulation signal emitted by the detection apparatus is a modulation signal superimposed on a control signal. When the infrared demodulation receiving tube receives the infrared modulation signal, the infrared demodulation receiving tube demodulates a low-level signal, and when the infrared demodulation receiving tube does not receive the infrared modulation signal, the infrared demodulation receiving tube demodulates a low-level signal. By means of detecting the high-level signal and the low-level signal, the detection apparatus can filter out external interference.

Preferably, the infrared transceiver unit further includes a telescopic traction mechanism, one end of the telescopic traction mechanism has a connection relationship with a mounting surface of the mounting skewed slot, and the other end of the telescopic traction mechanism is fixedly connected to the mounting slot for pulling the mounting skewed slot to perform telescopic movement. When colliding with an obstacle, the detection apparatus triggers a contact collision signal, so that the telescopic traction mechanism pulls the mounting slot to retract so as to drive the infrared transceiver unit to avoid direct contact with the obstacle, thereby protecting the infrared transceiver unit.

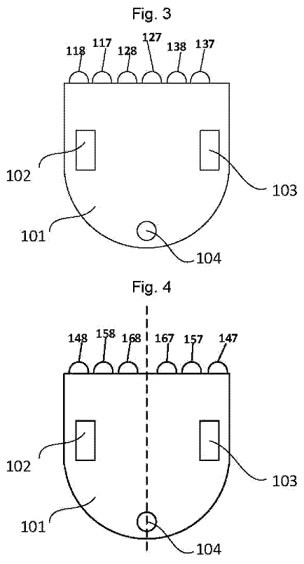

Based on the foregoing infrared transceiver unit, the present invention further provides a multi-infrared detection apparatus. As an embodiment of the multi-infrared detection apparatus assembled on a robot, as shown in FIG. 3, the multi-infrared detection apparatus includes a horizontally arranged mounting slot, at least two groups of infrared transceiver units arranged in pairs. In the present embodiment, three groups of infrared transceiver units arranged in pairs are provided, the infrared transceiver units arranged in pairs are two foregoing infrared transceiver units, and are distributed on the end face of the robot in the forward direction according to the structural features in FIG. 5, the three groups of infrared transceiver units arranged in pairs are continuously arranged in the mounting slot, specifically as shown in FIG. 3, a pair of infrared transceiver unit 118 and infrared transceiver unit 117 is arranged on the left side of the mounting slot, a pair of infrared transceiver unit 128 and infrared transceiver unit 127 is arranged at a middle position of the mounting slot, and a pair of infrared transceiver unit 138 and infrared transceiver unit 137 is arranged on the right side of the mounting slot. In combination with FIG. 2, FIG. 3 and FIG. 5, it can be seen that in the two infrared transceiver units arranged in pairs, for the infrared transceiver unit arranged on the left side, the infrared emitting source is fixedly installed in the right mounting skewed slot, and two groups of infrared receiving sources are fixedly installed in the left mounting skewed slot. For the convenience of illustration, in the present embodiment, the number of each group of infrared receiving sources is sent to be one, that is, there is only one infrared demodulation receiving pipe in each group. At the same time, for the infrared transceiver unit arranged on the right side, the infrared emitting source is fixedly installed in the left mounting skewed slot, and two infrared receiving sources are fixedly installed in the right mounting skewed slot. The signal transmission and reception conditions of the infrared modulation light of these infrared transceiver units arranged in pairs are the same as those of the foregoing detection apparatus. In the two infrared transceiver units arranged in pairs, one infrared transceiver unit receives the infrared modulation light emitted by the other infrared transceiver unit, or the infrared modulation light emitted by any of the infrared transceiver units and reflected by the obstacle, but the determination of the relative position of the obstacle and the center line of the infrared transceiver unit is more specific. Specifically, in a position region delimited by the center lines of the six infrared transceiver units, the specific detection position can be adjusted according to the intervals between different infrared transceiver units.

As shown in FIG. 4, the two infrared transceiver units arranged in pairs can also be respectively arranged on both sides of the horizontal center line of the mounting slot, and are symmetrically arranged from the outer side to the inner side of the mounting slot in sequence by taking the horizontal center line of the mounting slot as an axis of symmetry. Specifically, as shown in FIG. 4, an infrared transceiver unit 148 and an infrared transceiver unit 147 in a pair are respectively arranged on the leftmost end and the rightmost end of the mounting slot, and are symmetrical relative to the horizontal center line of the installation slot; an infrared transceiver unit 158 is arranged on the right side of the infrared transceiver unit 148, an infrared transceiver unit 157 is arranged on the left side of the infrared transceiver unit 147, and the infrared transceiver unit 158 and the infrared transceiver unit 157 are symmetrical relative to the horizontal center line of the installation slot; an infrared transceiver unit 168 is arranged on the right side of the infrared transceiver unit 158, an infrared transceiver unit 167 is arranged on the left side of the infrared transceiver unit 157, and the infrared transceiver unit 168 and the infrared transceiver unit 167 are symmetrical relative to the horizontal center line of the installation slot; and the signal transmission and reception conditions of the infrared modulation light of these infrared transceiver units arranged in pairs are the same as those of the foregoing detection apparatus. In the two infrared transceiver units arranged in pairs, one infrared transceiver unit receives the infrared modulation light emitted by the other infrared transceiver unit, or the infrared modulation light emitted by any of the infrared transceiver units and reflected by the obstacle, but the detection of the relative position of the obstacle and the center line of the infrared transceiver unit is more regular. Specifically, in a symmetrical position region delimited by the center lines of the six infrared transceiver units, the specific detection position can be adjusted according to the intervals between different infrared transceiver units. The infrared transceiver units in different pairs can emit the infrared modulation light in different time periods, so as to avoid the interference of multiple signals and to reduce the obstacle detection difficulty. Compared with the foregoing embodiment, the multi-infrared detection apparatus refines the detection position of the obstacle relative to the front end of the apparatus, thereby improving the detection effect.

Each infrared transceiver unit in the multi-infrared detection apparatus is preferably provided with a telescopic traction mechanism, one end of the telescopic traction mechanism has a connection relationship with the mounting surface of the mounting skewed slot, and the other end of the telescopic traction mechanism is fixedly connected to the mounting slot for pulling the mounting skewed slot to perform telescopic movement. When colliding with an obstacle, the detection apparatus triggers a contact collision signal, so that the telescopic traction mechanism pulls the mounting slot to retract so as to drive the infrared transceiver unit to avoid direct contact with the obstacle, thereby protecting the infrared transceiver unit.

Preferably, in the multi-infrared detection apparatus, there is at least one layer of infrared transceiver units that are arranged in the mounting slot, and adjacent layers are arranged in an alignment or malposition manner, which can be set according to the needs of a specific detection environment.

In the foregoing detection apparatus and the multi-infrared detection apparatus, the infrared transceiver units arranged in pairs are integrated to form an infrared detection obstacle avoidance apparatus, which has a wide detection region, a good detection effect and good detection sensitivity for both white obstacles and black obstacles. On this basis, the present invention further provides an obstacle avoidance robot, including a robot body 101 in FIG. 1, a robot left wheel 102, a robot right wheel 103, and a robot balance wheel 104 arranged on a central axis of the robot body 101, wherein the robot left wheel 102 is arranged on the left side of the central axis of the robot body 101, and the robot right wheel 103 is arranged on the right side of the central axis of the robot body 101, so that the robot body 101 can be applied to devices such as carrying robots and sweepers.

The foregoing detection apparatus is installed on the end face of the robot body 101 in the forward direction: the infrared transceiver unit 107 and the infrared transceiver unit 108 in FIG. 1. The infrared transceiver unit 108 and the infrared transceiver unit 107 are respectively arranged on the left end and the right end of the robot body 101. In the infrared transceiver unit 108 arranged on the left end of the robot body 101, the infrared emitting source is fixedly installed in the right mounting skewed slot, two groups of infrared receiving sources are fixedly installed in the left mounting skewed slot, one group of infrared receiving sources faces the inner side of the robot body 101, the other group of infrared receiving sources faces the outer side of the robot body 101, 105 represents the emitting direction of the infrared modulation light of the infrared transceiver unit 108, and 109 represents the receiving direction of the infrared modulation light of the infrared transceiver unit 108; and in the infrared transceiver unit 107 arranged on the right end of the mounting slot, the infrared emitting source is fixedly installed in the left mounting skewed slot, two groups of infrared receiving sources are fixedly installed in the right mounting skewed slot, one group of infrared receiving sources faces the inner side of the robot body 101, the other group of infrared receiving sources faces the outer side of the robot body 101, 106 represents the emitting direction of the infrared modulation light of the infrared transceiver unit 107, and 110 represents the receiving direction of the infrared modulation light of the infrared transceiver unit 107. It is worth noting that, when the detection apparatus is not provided with the telescopic traction mechanism, it can be installed in a concave mounting surface of the robot in the forward direction, therefore the robot is prevented from being clamped during an obstacle avoidance turning process, and meanwhile, an obstacle detection work can also be accomplished by means of the infrared transceiver unit 108 and the infrared transceiver unit 107 and their limiting structures; and when the detection apparatus is provided with the telescopic traction mechanism, the infrared transceiver unit 108 and the infrared transceiver unit 108 form a convex hull structure, including convex hulls located on the both sides of the front face of the robot, when the telescopic traction mechanism is provided with a movable spring structure, the convex hull has a certain elastic force for detecting external extrusion, can retract into the robot, and meanwhile triggers a signal of inform a control system of physical contact collision.

When the foregoing multi-infrared detection apparatus is installed on the end face of the robot body 101 in the forward direction, as shown in FIG. 3, the three pairs of infrared transceiver units arranged in pairs are continuously arranged in the mounting slot. As shown in FIG. 4, the three pairs of infrared transceiver units arranged in pairs are respectively arranged on the both sides of the horizontal center line of the mounting slot, and are symmetrically arranged from the outer side to the inner side of the mounting slot in sequence by taking the horizontal center line (a dotted line of the central axis of the robot body 101 in FIG. 4) of the mounting slot as an axis of symmetry. The signal transmission and reception conditions of the infrared modulation light of these infrared transceiver units arranged in pairs are the same as those of the foregoing detection apparatus. In the two infrared transceiver units arranged in pairs, one infrared transceiver unit receives the infrared modulation light emitted by the other infrared transceiver unit, or the infrared modulation light emitted by any of the infrared transceiver units and reflected by the obstacle. In the present embodiment, when the obstacle is located in a limited distance region between the sensing center lines of the mounting skewed slots of the two infrared transceiver units, each infrared transceiver unit can receive the infrared modulation light emitted by itself. When the obstacle is at a limited distance beyond the region between the sensing center lines of the mounting skewed slots of the two infrared transceiver units, for example, at a corner of a certain end of the detection apparatus, the infrared receiving source on the outer side (relative to the inner side of the mounting slot) of the infrared transceiver unit on this end can receive the signal emitted by the infrared transceiver unit on the other end; and when there is no obstacle, the infrared transceiver unit arranged on one end of the mounting slot receives the infrared modulation light emitted by the infrared transceiver unit arranged on the other end. It is worth noting that, when the detection apparatus is not provided with the telescopic traction mechanism, it can be installed in the concave mounting surface of the robot in the forward direction, therefore the robot is prevented from being clamped during the obstacle avoidance turning process, and meanwhile, the obstacle detection work can be accomplished by means of the infrared transceiver units arranged in pairs and their limiting structures; and when the detection apparatus is provided with the telescopic traction mechanism, the infrared transceiver units arranged in pairs form a convex hull structure, including convex hulls located on the both sides of the front face of the robot, when the telescopic traction mechanism is provided with a movable spring structure, the convex hull has a certain elastic force for detecting external extrusion, can retract into the robot, and meanwhile triggers a signal to inform the control system of physical contact collision.

The obstacle avoidance robot provided by the present embodiment can perform obstacle detection by using the infrared modulation light, realizes wide-range obstacle detection in front of the robot in cooperation with the structure, and overcomes the problem of a large difference in the detectable distances between black and white obstacles caused by the infrared modulation light in a limited region, therefore the detection effect is good, the perception ability of the robot is improved, and the robot can be prevented from being clamped during the obstacle avoidance turning process.

Finally, it should be noted that the above embodiments are only used for illustrating the technical solutions of the present invention, rather than limiting the same. Although the present invention has been described in detail with reference to the preferred embodiments, those of ordinary skill in the art to which the present invention belongs should understand that: it is still possible to make modifications to specific embodiments of the present invention or make equivalent replacements to some technical features; and without departing from the spirit of the technical solutions of the present invention, all these modifications and equivalent replacements should be included in the scope of the technical solutions claimed in the present invention.

What is claimed is:

1. An infrared transceiver unit, comprising a mounting skewed slot, an infrared emitting source and infrared receiving sources, wherein the mounting skewed slot comprises a left mounting skewed slot and a right mounting skewed slot; the infrared emitting source is fixedly installed in the left mounting skewed slot, and two groups of infrared receiving sources are fixedly installed in the right mounting skewed slot, or the infrared emitting source is fixedly installed in the right mounting skewed slot, and two groups of infrared receiving sources are fixedly installed in the left mounting skewed slot; and
a sensing direction of one group of infrared receiving sources and an emitting direction of the infrared emitting source both face one side of a sensing center line of the mounting skewed slot, and the sensing direction of the other group of infrared receiving sources faces the other side of the sensing center line of the mounting skewed slot, so that one of the infrared receiving sources receives infrared modulation light emitted by the infrared emitting source and reflected by an obstacle.

2. The infrared transceiver unit according to claim 1, wherein one group of infrared receiving sources is inclined in the same direction as the infrared emitting source, the two groups of infrared receiving sources receive the infrared modulation light by means of respective light path channel ports at diffusion angles, so as to form a receiving range of the mounting skewed slot, the infrared emitting source emits the infrared modulation light by means of its light path channel port at a diffusion angle, so as to form an emitting range of the mounting skewed slot, wherein the receiving range is greater than the emitting range.

3. (canceled)

4. (canceled)

5. The infrared transceiver unit according to claim 41, further comprising a telescopic traction mechanism, wherein the telescopic traction mechanism has a connection relationship with a mounting surface of the mounting skewed slot for pulling the mounting skewed slot to perform telescopic movement.

6. (canceled)

7. A detection apparatus, wherein the detection apparatus comprises two infrared transceiver units and a horizontally arranged mounting slot;
the two infrared transceiver units are respectively arranged on a left end and a right end of the mounting slot, so that the two infrared transceiver units are located on both sides of the detection apparatus, and the infrared transceiver unit arranged on one end of the mounting slot receives: infrared modulation light emitted by the infrared transceiver unit arranged on the other end of the mounting slot, or infrared modulation light emitted by the infrared transceiver unit arranged on either end of the mounting slot and reflected by an obstacle;
in the infrared transceiver unit arranged on the left end of the mounting slot, the infrared emitting source is fixedly installed in the right mounting skewed slot, and two groups of infrared receiving sources are fixedly installed in the left mounting skewed slot, one group of infrared receiving sources faces an inner side of the mounting slot, and the other group of infrared receiving sources faces an outer side of the mounting slot; and in the infrared transceiver unit arranged on the right end of the mounting slot, the infrared emitting source is fixedly installed in the left mounting skewed slot, and two groups of infrared receiving sources are fixedly installed in the right mounting skewed slot, one group of infrared receiving sources faces the inner side of the mounting slot, and the other group of infrared receiving sources faces the outer side of the mounting slot;
wherein the infrared transceiver unit, comprising a mounting skewed slot, an infrared emitting source and infrared receiving sources, wherein the mounting skewed slot comprises a left mounting skewed slot and a right mounting skewed slot: the infrared emitting source is fixedly installed in the left mounting skewed slot, and two groups of infrared receiving sources are fixedly installed in the right mounting skewed slot, or the infrared emitting source is fixedly installed in the right mounting skewed slot, and two groups of infrared receiving sources are fixedly installed in the left mounting skewed slot; and
a sensing direction of one group of infrared receiving sources and an emitting direction of the infrared emitting source both face one side of a sensing center line of the mounting skewed slot, and the sensing direction of the other group of infrared receiving sources faces the other side of the sensing center line of the mounting skewed slot, so that one of the infrared receiving sources receives infrared modulation light emitted by the infrared emitting source and reflected by an obstacle.

8. The detection apparatus according to claim 7, wherein the infrared transceiver unit further comprises a telescopic traction mechanism, one end of the telescopic traction mechanism has a connection relationship with the mounting surface of the mounting skewed slot, and the other end of the telescopic traction mechanism is fixedly connected to the mounting slot for pulling the mounting skewed slot to perform telescopic movement.

9. A multi-infrared detection apparatus, wherein the multi-infrared detection apparatus comprises a horizontally arranged mounting slot, and at least two groups of infrared transceiver units arranged in pairs, and the infrared transceiver units arranged in pairs are two foregoing infrared transceiver units; these infrared transceiver units arranged in pairs are continuously arranged in the mounting slot, or, the two infrared transceiver units arranged in pairs are respectively arranged on both sides of a horizontal center line of the mounting slot, and are symmetrically arranged from the outer side to the inner side of the mounting slot in sequence by taking the horizontal center line of the mounting slot as an axis of symmetry;
in the two infrared transceiver units arranged in pairs, one infrared transceiver unit receives the infrared modulation light emitted by the other infrared transceiver unit, or, the infrared modulation light emitted by any of the infrared transceiver units and reflected by an obstacle;
in the two infrared transceiver units arranged in pairs, for the infrared transceiver unit arranged on a left side, the infrared emitting source is fixedly installed in the right mounting skewed slot, and two groups of infrared receiving sources are fixedly installed in the left mounting skewed slot; and for the infrared transceiver unit arranged on a right side, the infrared emitting source is fixedly installed in the left mounting skewed slot, and two groups of infrared receiving sources are fixedly installed in the right mounting skewed slot;
wherein the infrared transceiver unit, comprising a mounting skewed slot, an infrared emitting source and infrared receiving sources, wherein the mounting skewed slot comprises a left mounting skewed slot and a right mounting skewed slot; the infrared emitting source is fixedly installed in the left mounting skewed slot, and two groups of infrared receiving sources are fixedly installed in the right mounting skewed slot, or the infrared emitting source is fixedly installed in the right mounting skewed slot, and two groups of infrared receiving sources are fixedly installed in the left mounting skewed slot; and
a sensing direction of one group of infrared receiving sources and an emitting direction of the infrared emitting source both face one side of a sensing center line of the mounting skewed slot, and the sensing direction of the other group of infrared receiving sources faces the other side of the sensing center line of the mounting skewed slot, so that one of the infrared receiving sources receives infrared modulation light emitted by the infrared emitting source and reflected by an obstacle.

10. The multi-infrared detection apparatus according to claim 9, wherein the infrared transceiver unit further comprises a telescopic traction mechanism, one end of the telescopic traction mechanism has a connection relationship with the mounting surface of the mounting skewed slot, and the other end of the telescopic traction mechanism is fixedly connected to the mounting slot for pulling the mounting skewed slot to perform telescopic movement.

11. The multi-infrared detection apparatus according to claim 9, wherein there is at least one layer of infrared transceiver units that are continuously arranged in the mounting slot, and adjacent layers are arranged in an alignment or malposition manner.

12. An obstacle avoidance robot, wherein the infrared transceiver unit, comprising a mounting skewed slot, an infrared emitting source and infrared receiving sources, wherein the mounting skewed slot comprises a left mounting skewed slot and a right mounting skewed slot; the infrared emitting source is fixedly installed in the left mounting skewed slot, and two groups of infrared receiving sources are fixedly installed in the right mounting skewed slot, or the infrared emitting source is fixedly installed in the right mounting skewed slot, and two groups of infrared receiving sources are fixedly installed in the left mounting skewed slot; and
a sensing direction of one group of infrared receiving sources and an emitting direction of the infrared emitting source both face one side of a sensing center line of the mounting skewed slot, and the sensing direction of the other group of infrared receiving sources faces the other side of the sensing center line of the mounting skewed slot, so that one of the infrared receiving sources receives infrared modulation light emitted by the infrared emitting source and reflected by an obstacle.

13. The obstacle avoidance robot according to claim 12, wherein the infrared transceiver unit is installed in a concave mounting surface of the robot in a forward direction; or, the infrared transceiver unit is installed on an end face of the robot in the forward direction

14. The detection apparatus according to claim 7, wherein one group of infrared receiving sources is inclined in the same direction as the infrared emitting source, the two groups of infrared receiving sources receive the infrared modulation light by means of respective light path channel ports at diffusion angles, so as to form a receiving range of the mounting skewed slot, the infrared emitting source emits the infrared modulation light by means of its light path channel port at a diffusion angle, so as to form an emitting range of the mounting skewed slot, wherein the receiving range is greater than the emitting range.

15. The multi-infrared detection apparatus according to claim 9, wherein one group of infrared receiving sources is inclined in the same direction as the infrared emitting source, the two groups of infrared receiving sources receive the infrared modulation light by means of respective light path channel ports at diffusion angles, so as to form a receiving range of the mounting skewed slot, the infrared emitting source emits the infrared modulation light by means of its light path channel port at a diffusion angle, so as to form an emitting range of the mounting skewed slot, wherein the receiving range is greater than the emitting range.

16. The obstacle avoidance robot according to claim 13, wherein one group of infrared receiving sources is inclined in the same direction as the infrared emitting source, the two groups of infrared receiving sources receive the infrared modulation light by means of respective light path channel ports at diffusion angles, so as to form a receiving range of the mounting skewed slot, the infrared emitting source emits the infrared modulation light by means of its light path channel port at a diffusion angle, so as to form an emitting range of the mounting skewed slot, wherein the receiving range is greater than the emitting range.

17. The obstacle avoidance robot according to claim 13, wherein the detection apparatus comprises two infrared transceiver units and a horizontally arranged mounting slot;
the two infrared transceiver units are respectively arranged on a left end and a right end of the mounting slot, so that the two infrared transceiver units are located on both sides of the detection apparatus, and the infrared transceiver unit arranged on one end of the mounting slot receives: infrared modulation light emitted by the infrared transceiver unit arranged on the other end of the mounting slot, or infrared modulation light emitted by the infrared transceiver unit arranged on either end of the mounting slot and reflected by an obstacle;
in the infrared transceiver unit arranged on the left end of the mounting slot, the infrared emitting source is fixedly installed in the right mounting skewed slot, and two groups of infrared receiving sources are fixedly installed in the left mounting skewed slot, one group of infrared receiving sources faces an inner side of the mounting slot, and the other group of infrared receiving sources faces an outer side of the mounting slot; and in the infrared transceiver unit arranged on the right end of the mounting slot, the infrared emitting source is fixedly installed in the left mounting skewed slot, and two groups of infrared receiving sources are fixedly installed in the right mounting skewed slot, one group of infrared receiving sources faces the inner side of the mounting slot, and the other group of infrared receiving sources faces the outer side of the mounting slot.

18. The obstacle avoidance robot according to claim 17, wherein the detection apparatus is installed in a concave mounting surface of the robot in a forward direction; or, the detection apparatus is installed on an end face of the robot in the forward direction.

19. The obstacle avoidance robot according to claim 13, wherein the multi-infrared detection apparatus comprises a horizontally arranged mounting slot, and at least two groups of infrared transceiver units arranged in pairs, and the infrared transceiver units arranged in pairs are two foregoing infrared transceiver units; these infrared transceiver units arranged in pairs are continuously arranged in the mounting slot, or, the two infrared transceiver units arranged in pairs are respectively arranged on both sides of a horizontal center line of the mounting slot, and are symmetrically arranged from the outer side to the inner side of the mounting slot in sequence by taking the horizontal center line of the mounting slot as an axis of symmetry;
in the two infrared transceiver units arranged in pairs, one infrared transceiver unit receives the infrared modulation light emitted by the other infrared transceiver unit, or, the infrared modulation light emitted by any of the infrared transceiver units and reflected by an obstacle;
in the two infrared transceiver units arranged in pairs, for the infrared transceiver unit arranged on a left side, the infrared emitting source is fixedly installed in the right mounting skewed slot, and two groups of infrared receiving sources are fixedly installed in the left mounting skewed slot; and for the infrared transceiver unit arranged on a right side, the infrared emitting source is fixedly installed in the left mounting skewed slot, and two groups of infrared receiving sources are fixedly installed in the right mounting skewed slot.

20. The obstacle avoidance robot according to claim 19, wherein the multi-infrared detection apparatus is installed in a concave mounting surface of the robot in a forward direction; or, the multi-infrared detection apparatus is installed on an end face of the robot in the forward direction.

21. The obstacle avoidance robot according to claim 13, wherein the infrared transceiver unit further comprises a telescopic traction mechanism, one end of the telescopic traction mechanism has a connection relationship with the mounting surface of the mounting skewed slot, and the other end of the telescopic traction mechanism is fixedly connected to the mounting slot for pulling the mounting skewed slot to perform telescopic movement.

22. The obstacle avoidance robot according to claim 13, wherein there is at least one layer of infrared transceiver units that are continuously arranged in the mounting slot, and adjacent layers are arranged in an alignment or malposition manner.
